(19) United States
(12) Patent Application Publication
(10) Pub. No.: US 2007/0032621 A1
(43) Pub. Date: Feb. 8, 2007

(54) Novel polyvinyl alcohols and novel polyvinyl alcohol copolymers

(75) Inventors: Jorg Ludwig Schulte, Konrad-Brossnitz-Strasse (DE); Tim Dickner, Solmsstrasse (DE); Monika Bruckmann, Kleine Nelkenstrasse (DE); Jorg Schottek, Ginnheimerstrasse (DE); Uwe Blank, Wiesbaden (DE)

Correspondence Address: CONNOLLY BOVE LODGE & HUTZ, LLP, P O BOX 2207, WILMINGTON, DE, 19899, US

(73) Assignee: Celanese Ventures GmbH, Frankfurt am Main (DE)

(21) Appl. No.: 10/572,649

(22) PCT Filed: Sep. 17, 2004
(86) PCT No.: PCT/EP04/10438

§ 371 Date: Mar. 20, 2006

(30) Foreign Application Priority Data
Sep. 20, 2003 (DE) 103 43 607.3

(51) Int. Cl. C08F 218/02

(52) U.S. Cl. 526/330

(57) ABSTRACT

The present invention relates to polyvinyl alcohols, to polyvinyl alcohol copolymers having specific geometries, to a process for preparing such polyvinyl alcohols and polyvinyl alcohol copolymers, and to their use.

The present invention relates to polyvinyl alcohols, to polyvinyl alcohol copolymers, to processes for preparing polyvinyl alcohols and polyvinyl alcohol copolymers, to processes for modifying polyvinyl alcohols and polyvinyl alcohol copolymers, and to the use of polyvinyl alcohols and polyvinyl alcohol copolymers and of derivatives of polyvinyl alcohols and polyvinyl alcohol copolymers.

Polyvinyl alcohols are prepared industrially by hydrolysis from polyvinyl acetate and have the moiety

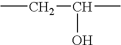

as the basic building blocks of the macromolecules. Commercially customary polyvinyl alcohols may have different degrees of hydrolysis; in other words, they may still have a residual acetyl group content. These polymers can be considered polyvinyl alcohol-polyvinyl acetate copolymers. Polyvinyl alcohols are employed primarily for the following areas of application: as a protective colloid, emulsifier, binder, for protective skins and adhesives, textile finishes, sizes, metal-protection coatings, for preparing ointments and emulsions, water-soluble pouches and packaging films, oil-, grease-, and fuel-resistant hoses and seals, as an additive to shaving cream and to soaps, as a thickener in pharmaceutical and cosmetics products, and as an artificial tear liquid. Polyvinyl alcohol can be spun to water-soluble fibers, known as vinal fibers, or foamed to form sponges. As reactive polymers, which can be given broad chemical variation via the secondary hydroxide groups (acetalization, esterification, etherification or crosslinking), polyvinyl alcohols serve as base materials for the preparation, for example, of polyvinyl acetals (e.g., polyvinyl butyrals) (Römpp Lexikon Chemie—Version 2.0, Stuttgart/New York: Georg Thieme Verlag 1999).

Commercially customary polyvinyl alcohols are more or less linear polymers which are prepared by free-radical polymerizations of vinyl acetate followed by hydrolysis of the ester linkage. Polyvinyl alcohols having specific geometries, such as polyvinyl alcohol star polymers, have not hitherto been described.

Surprisingly it has now been found that through hydrolysis of polyvinyl esters and polyvinyl ester copolymers having specific geometries, which are described in DE 10238659, it is possible to obtain polyvinyl alcohols and polyvinyl alcohol copolymers which feature a relatively low melting point and improve processing properties.

The present invention provides polymers of the formulae I, II, and III:

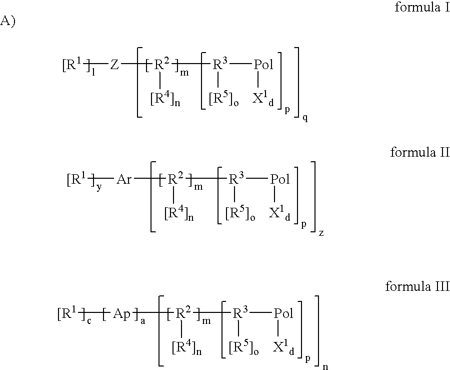

in which

Pol is a polymer based on a polyvinyl alcohol, more preferably a homopolymer or copolymer based on polyvinyl alcohol, with particular preference polyvinyl alcohol, polyvinyl alcohol-polyvinyl acetate copolymer, polyvinyl alcohol-polyethylene copolymer, polyvinyl alcohol-polyvinyl chloride copolymer, and polyvinyl alcohol-polymethyl acrylate copolymer, and

Z is a central atom and is an atom from groups 13 to 16 of the Periodic Table of the Elements, preferably carbon, silicon, nitrogen, phosphorus, oxygen or sulfur, more preferably carbon or silicon, and

X¹ is identical or different at each occurrence and is a halogen atom, preferably fluorine, chlorine, bromine or iodine, more preferably chlorine, bromine or iodine, and

R¹ is identical or different and is hydrogen or a C₁-C₂₀ group, and

R² is identical or different and is a bridging C₁-C₂₀ group between the central atom Z and the initiating unit [R³—X¹] or silicon or oxygen, and

R³ is identical or different and is carbon or silicon, and

R⁴ is identical or different and is a hydrogen atom or a C₁-C₂₀ group, and

R⁵ is identical or different and is hydrogen or a C₁-C₂₀ group,

l is a whole natural number and is zero, 1, 2 or 3, and

m is identical or different at each occurrence and is a whole natural number and is zero, 1, 2, 3, 4 or 5, and

n is identical or different at each occurrence and is a whole natural number and is zero, 1, 2, 3, 4, 5, 6, 7, 8, 9, 10, 11, 12, 13, 14, 15, 16, 17, 18, 19 or 20, and

• is identical or different at each occurrence and is 1 or 2, and

p is identical or different at each occurrence and is a whole natural number and is 1, 2, 3, 4 or 5, and

q is a whole natural number and is 2, 3 or 4, and

Ar is an aromatic parent structure having at least four carbon atoms, in which one or more carbons may have been replaced by boron, nitrogen or phosphorus, with preferred aromatic or heteroaromatic parent structures deriving from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which where appropriate may also be substituted, in particular by a C₁-C₂₀ group, and

y is a whole natural number and is zero, 1, 2, 3, 4, 5, 6, 7, 8, 9, 10, 11, 12, 13, 14, 15, 16, 17, 18, 19 or 20, and

z is a whole natural number and is 2, 3, 4, 5, 6, 7, 8, 9, or 10,

Ap is a cyclic nonaromatic parent structure which has at least three carbon atoms and may also contain heteroatoms such as nitrogen, boron, phosphorus, oxygen or sulfur, with preferred aliphatic parent structures deriving from the cycloalkyl group, such as cyclopropyl, cyclobutyl, cyclopentyl, cyclohexyl, cycloheptyl, cyclooctyl or cyclononyl, or from the cycloheteroalkyl group, such as aziridine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, or from the saccharides group, such as alpha-glucose or beta-glucose, and

a is a whole natural number and is zero, 1, 2, 3, 4, 5, 6, 7, 8, 9, 10, 11, 12, 13, 14, 15, 16, 17, 18, 19 or 20, and

b is a whole natural number and is 2, 3, 4, 5, 6, 7, 8, 9 or 10, and

c is a whole natural number and is zero, 1, 2, 3, 4, 5, 6, 7, 8, 9, 10, 11, 12, 13, 14, 15, 16, 17, 18, 19 or 20, and

d can be identical or different and is zero or one.

In the context of the present invention, a C₁-C₂₀ group encompasses preferably the radicals C₁-C₂₀ alkyl, more preferably methyl, ethyl, n-propyl, isopropyl, n-butyl, isobutyl, sec-butyl, tert-butyl, n-pentyl, sec-pentyl, cyclopentyl, n-hexyl, cyclohexyl, n-octyl or cyclooctyl, C₁-C₂₀ alkenyl, more preferably ethenyl, propenyl, butenyl, pentenyl, cyclopentenyl, hexenyl, cyclohexenyl, octenyl or cyclooctenyl, C₁-C₂₀ alkynyl, more preferably ethynyl, propynyl, butynyl, pentynyl, hexynyl or octynyl, C₆-C₂₀ aryl, more preferably phenyl, biphenylyl, naphthyl or anthracenyl, C₁-C₂₀ fluoroalkyl, more preferably trifluoromethyl, pentafluoroethyl or 2,2,2-trifluoroethyl, C₆-C₂₀ aryl, more preferably phenyl, biphenylyl, naphthyl, anthracenyl, triphenylenyl, [1,1′:3′,1″]terphenyl-2′-yl, binaphthyl or phenanthrenyl, C₆-C₂₀ fluoroaryl, more preferably tetrafluorophenyl or heptafluoronaphthyl, C₁-C₂₀ alkoxy, more preferably methoxy, ethoxy, n-propoxy, isopropoxy, n-butoxy, isobutyoxy, sec-butoxy or tert-butoxy, C₆-C₂₀ aryloxy, more preferably phenoxy, naphthoxy, biphenylyloxy, anthracenyloxy, phenanthrenyloxy, C₇-C₂₀ arylalkyl, more preferably o-tolyl, m-tolyl, p-tolyl, 2,6-dimethylphenyl, 2,6-diethylphenyl, 2,6-diisopropylphenyl, 2,6-di-tert-butylphenyl, o-tert-butylphenyl, m-tert-butylphenyl, p-tert-butylphenyl, C₇-C₂₀ alkylaryl, more preferably benzyl, ethylphenyl, propylphenyl, diphenylmethyl, triphenylmethyl or naphthylmethyl, C₇-C₂₀ aryloxyalkyl, more preferably o-methoxyphenyl, m-phenoxymethyl, p-phenoxymethyl, C₁₂-20 aryloxyaryl, more preferably p-phenoxyphenyl, C₅-C₂₀ heteroaryl, more preferably 2-pyridyl, 3-pyridyl, 4-pyridyl, quinolyl, isoquinolyl, acridinyl, benzoquinolyl or benzisoquinolyl, C₄-C₂₀ heterocycloalkyl, more preferably furyl, benzofuryl, 2-pyrrolidinyl, 2-indolyl, 3-indolyl, 2,3-dihydroindolyl, C₈-C₂₀ arylalkenyl, more preferably o-vinylphenyl, m-vinylphenyl, p-vinylphenyl, C₈-C₂₀ arylalkynyl, more preferably o-ethynylphenyl, m-ethynylphenyl or p-ethynylphenyl, C₂-C₂₀ heteroatom-containing group, more preferably carbonyl, benzoyl, oxybenzoyl, benzoyloxy, acetyl, acetoxy or nitrile, it being possible for one or more C₁-C₂₀ groups to form a cyclic system.

In the context of the present invention a bridging C₁-C₂₀ group is preferably C₁-C₂₀ alkyl, more preferably methylene, ethylene, propylene, butylene, pentylene, cyclopentylene, hexylene or cyclohexylene, C₁-C₂₀ alkenyl, more preferably ethenyl, propenyl, butenyl, pentenyl, cyclopentenyl, hexenyl or cyclohexenyl, C₁-C₂₀ alkynyl, more preferably ethynyl, propynyl, butynyl, pentynyl or hexynyl, C₁-C₂₀ aryl, more preferably o-phenylene, m-phenylene or p-phenylene, or C₁-C₂₀ heteroatom-containing group, more preferably carbonyl, oxycarbonyl, carbonyloxy, carbamoyl or amido.

The preparation of the starting materials for preparing the polymers of the invention is disclosed in the as yet unpublished German patent application DE 10238659.

The invention further provides a process for preparing the polymers of the invention, comprising the following steps:
A) dissolving the polyvinyl ester prepared in accordance with DE 10238659 in one or more organic solvents,
B) adding the solution from A) dropwise to a solution of an acid or a solution of a base in one or more aqueous or one or more organic solvents, where appropriate with heating and stirring,
C) reacting the mixture from B) for a defined period, where appropriate with heating and stirring,
D) isolating the polymer by filtering or centrifuging the mixture from C),
E) washing the polymer with an organic solvent, and
F) drying the polymer.

The solvents employed in steps A) and E) are preferably (i) aromatic hydrocarbons, especially toluene, benzene or xylene, (ii) ketones, especially acetone, diethyl ketone or methyl isobutyl ketone, (iii) ethers, especially diethyl ether, dibutyl ether, methyl tert-butyl ether, tetrahydrofuran, anisole or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and (vii) ethylene carbonate or (viii) N,N-dimethylformamide.

The acids employed in step B) are preferably organic and/or inorganic acids, especially hydrogen fluoride, hydrochloric acid, hydrogen bromide, hydrogen iodide, phosphoric acid, phosphorous acid, hypophosphorous acid, sulfuric acid, sulfurous acid, acetic acid, tartaric acid, nitric acid, nitrous acid, ammonium chloride or citric acid. The bases employed in step M) are preferably organic and/or inorganic bases, especially sodium hydroxide, potassium hydroxide, sodium methoxide, sodium ethoxide, sodium propoxide, sodium isopropoxide, sodium butoxide, potassium methoxide, potassium ethoxide, potassium propoxide, potassium isopropoxide, potassium butoxide, magnesium hydroxide, calcium hydroxide, ammonia, tetramethylethylenediamine, trimethylamine, triethylamine, sodium EDTA or hexamethylenetetramine. The solvents employed in step B) are preferably (i) aromatic hydrocarbons, especially toluene, benzene or xylene, (ii) ketones, especially acetone, diethyl ketone or methyl isobutyl ketone, (iii) ethers, especially diethyl ether, dibutyl ether, methyl tert-butyl ether, tetrahydrofuran, anisole or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and (vii) ethylene carbonate or (viii) N,N-dimethylformamide, and also water.

The degree of hydrolysis of the polymer can be set by way of the reaction period in step C): a shorter reaction period leads to a lower degree of hydrolysis, while a longer reaction period leads to complete hydrolysis.

One preferred embodiment of the process of the invention comprises dissolving the polymer from step A) in methanol and/or acetone, adding the solution dropwise to a methanolic or aqueous solution of an inorganic base as per step B), reacting the mixture from B) at elevated temperature as per step C) for a defined period, filtering the suspension as per step D) and washing the polymer with methanol and/or acetone as per step E), and drying the polymer as per step F).

One particularly preferred embodiment of the process of the invention comprises dissolving the polymer from step A) in methanol, adding the solution dropwise to a methanolic solution of sodium hydroxide (1% NaOH in methanol) as per step B), reacting the mixture from B) at 50° C. as per step C) for one hour, filtering the suspension as per step D) and washing the polymer with methanol as per step E), and drying the polymer as per step F).

The hydrolysis of the polyvinyl esters and polyvinyl ester copolymers with specific geometries which have been prepared in accordance with DE 10238659 can be carded out either batchwise or continuously in accordance with EP 0 942 008. In the course of the hydrolysis it is possible if desired to add an additive which prevents yellowing of the polyvinyl alcohol or polyvinyl alcohol copolymer. Examples of such additives are described in U.S. Pat. No. 2,862,916, GB 808,108, and U.S. Pat. No. 6,046,272.

The resultant polyvinyl alcohols and polyvinyl alcohol copolymers are notable for a low melting point and improved processing properties.

The invention further provides for the reaction of the polyvinyl alcohols or polyvinyl alcohol copolymers prepared as above to give polyvinyl acetals or polyvinyl acetal copolymers, which comprises the following steps:

dissolving the polymer from step F) in water or an aqueous solution of an acid,

adding the solution from G) dropwise to a ketone or an aldehyde, where appropriate with stirring and heating,

reacting the mixture from H) for a defined period, where appropriate with heating and stirring,

if desired, adding an acid and reacting the mixture for a defined period, where appropriate with heating and stirring,

isolating the polymer by filtering the mixture from I) or J) and washing the polymer with water,

if desired, purifying the polymer by dissolving it in an organic solvent and precipitating it by adding the solution to water, and isolating the polymer, by filtration for example,

drying the polymer.

The acids employed in steps G) and J) are preferably organic and/or inorganic acids, particularly hydrogen fluoride, hydrochloric acid, hydrogen bromide, hydrogen iodide, phosphoric acid, phosphorous acid, hypophosphorous acid, sulfuric acid, sulfurous acid, acetic acid, tartaric acid, nitric acid, nitrous acid, ammonium chloride or citric acid.

The aldehydes and ketones employed in step H) are preferably formaldehyde, acetaldehyde, propionaldehyde, butyraldehyde, pentanal, hexanal, heptanal, octanal, nonanal, decanal, acetone, diethyl ketone, methyl ethyl ketone or methyl isobutyl ketone.

The solvents employed in step L) are preferably (i) aromatic hydrocarbons, especially toluene, benzene or xylene, (ii) ketones, especially acetone, diethyl ketone or methyl isobutyl ketone, (iii) ethers, especially diethyl ether, dibutyl ether, methyl tert-butyl ether, tetrahydrofuran, anisole or dioxane, (iv) esters, particularly those such as methyl acetate or ethyl acetate, (v) alcohols, especially methanol, ethanol or isopropanol, (vi) halogenated hydrocarbons, especially dichloromethane or trichloromethane, and also (vii) ethylene carbonate or (viii) N,N-dimethylformamide.

One preferred embodiment of the process of the invention comprises dissolving the polymer as per step G) in water or aqueous solution of an acid, adding the solution from G) dropwise to a ketone or an aldehyde as per step H), reacting the mixture from H) at elevated temperature as per step I) for a defined period, optionally adding an acid, filtering the suspension from I) or from J) and washing the polymer with water as per step K), optionally purifying the polymer by dissolving it in an organic solvent and precipitating it by adding the solution to an aqueous solvent as per step L), and drying the polymer as per step M).

One particularly preferred embodiment of the process of the invention comprises dissolving the polymer as per step G) in 0.5%-1% strength aqueous sulfuric acid, adding the solution from G) dropwise to butyraldehyde as per step H), reacting the mixture from H) at 50-55° C. as per step I) for two minutes, adding 2% of concentrated sulfuric acid and stirring the mixture at 50-55° C. for one hour as per step J), filtering the suspension from J) and washing the polymer with water as per step K), purifying the polymer by dissolving it in methanol and precipitating it by adding the solution to water as per step L), and drying the polymer as per step M).

The reaction of the polyvinyl alcohols and polyvinyl alcohol copolymers having specific geometries, prepared as described under step A)-F), to give polyvinyl acetals or polyvinyl acetal copolymers having specific geometries can be carried out either batchwise or continuously, and in the absence or presence of additives.

The invention further provides for chemical modification of the polyvinyl alcohols and polyvinyl alcohol copolymers of the invention to give polyvinyl esters and polyvinyl ester copolymers, to give polyvinyl ethers and polyvinyl ether copolymers, and to give crosslinked polyvinyl alcohols and polyvinyl alcohol copolymers.

Illustrative examples, but not restricting the invention, of polymers of the formula I, II, and III are:

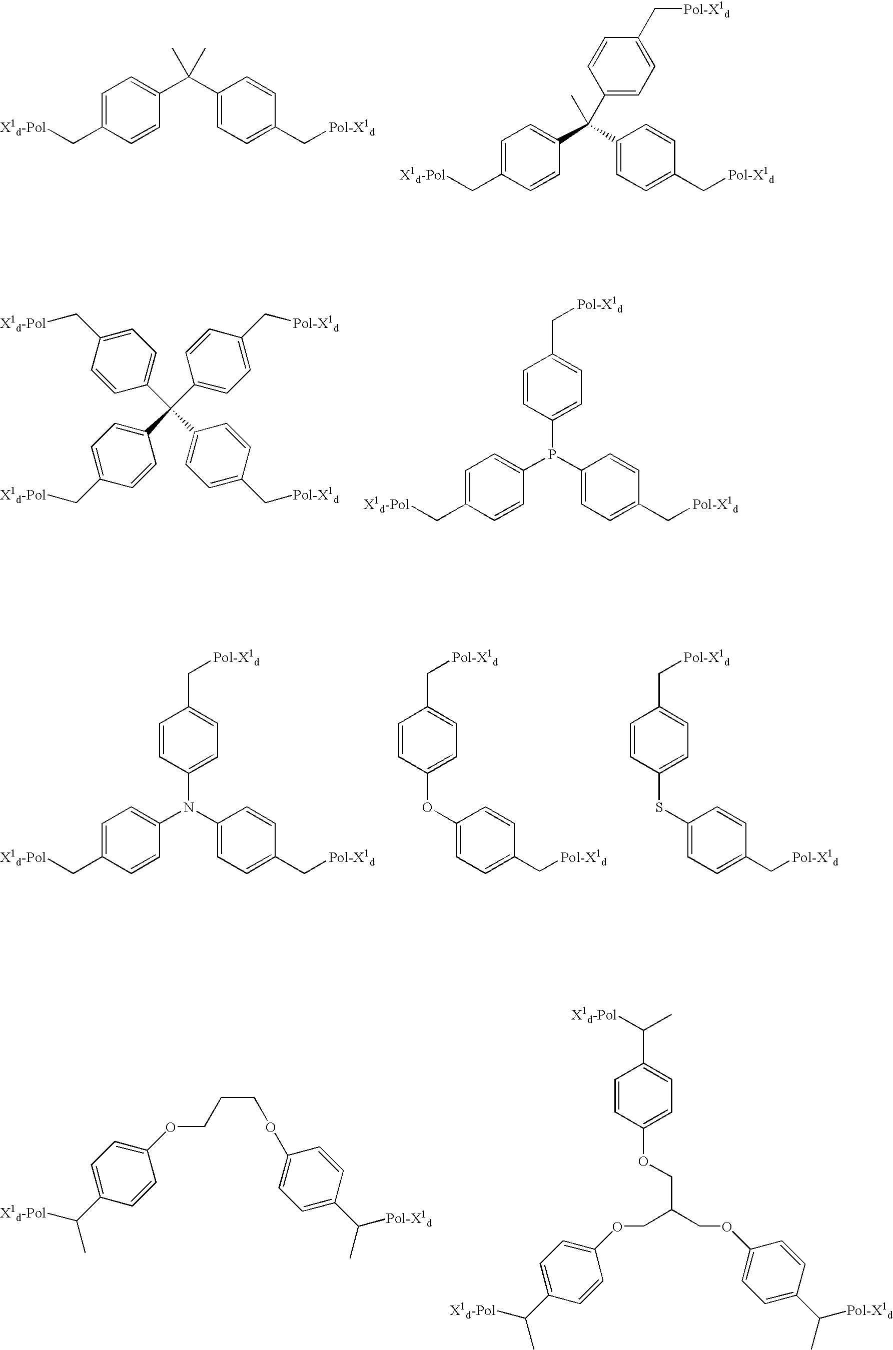

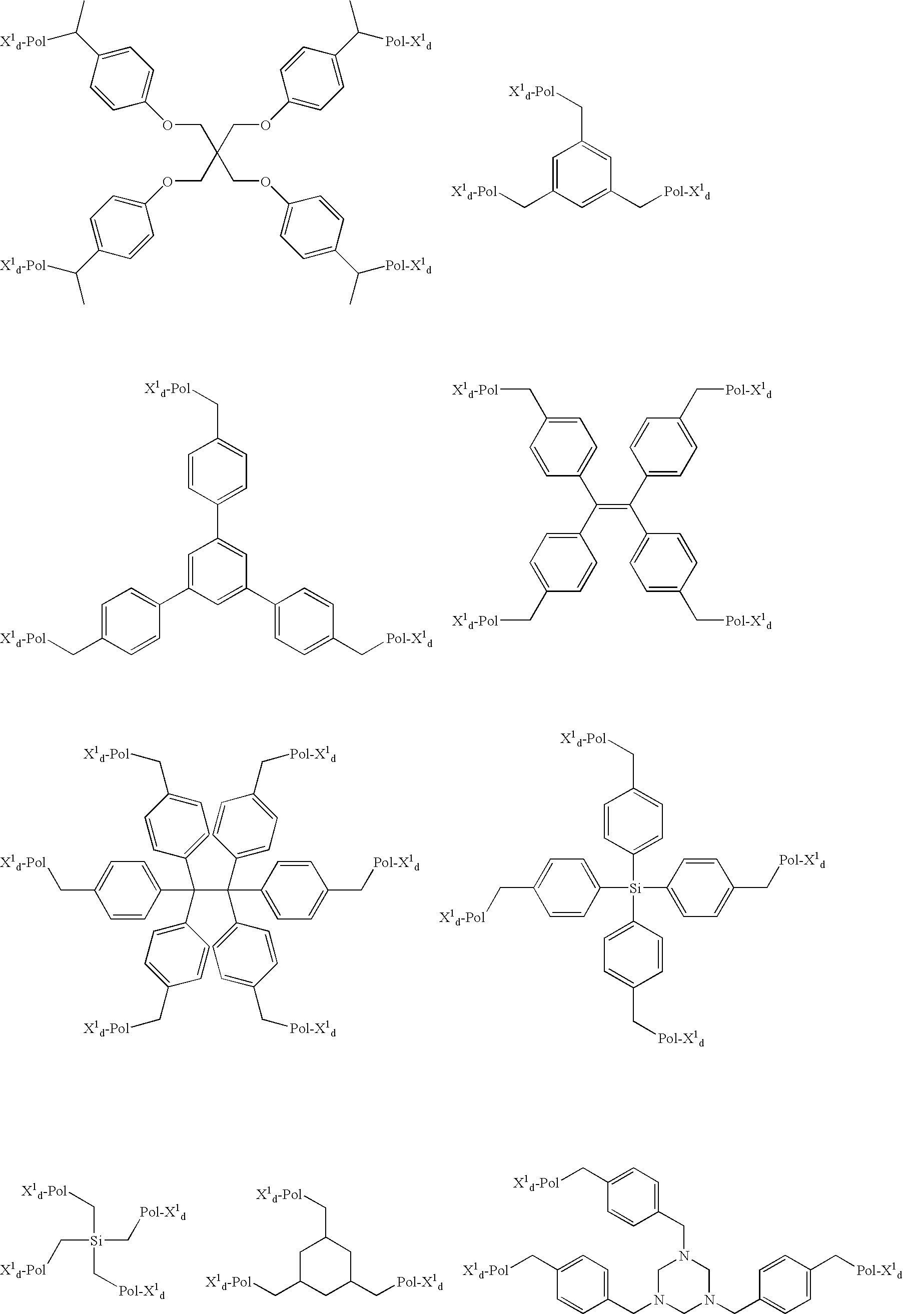

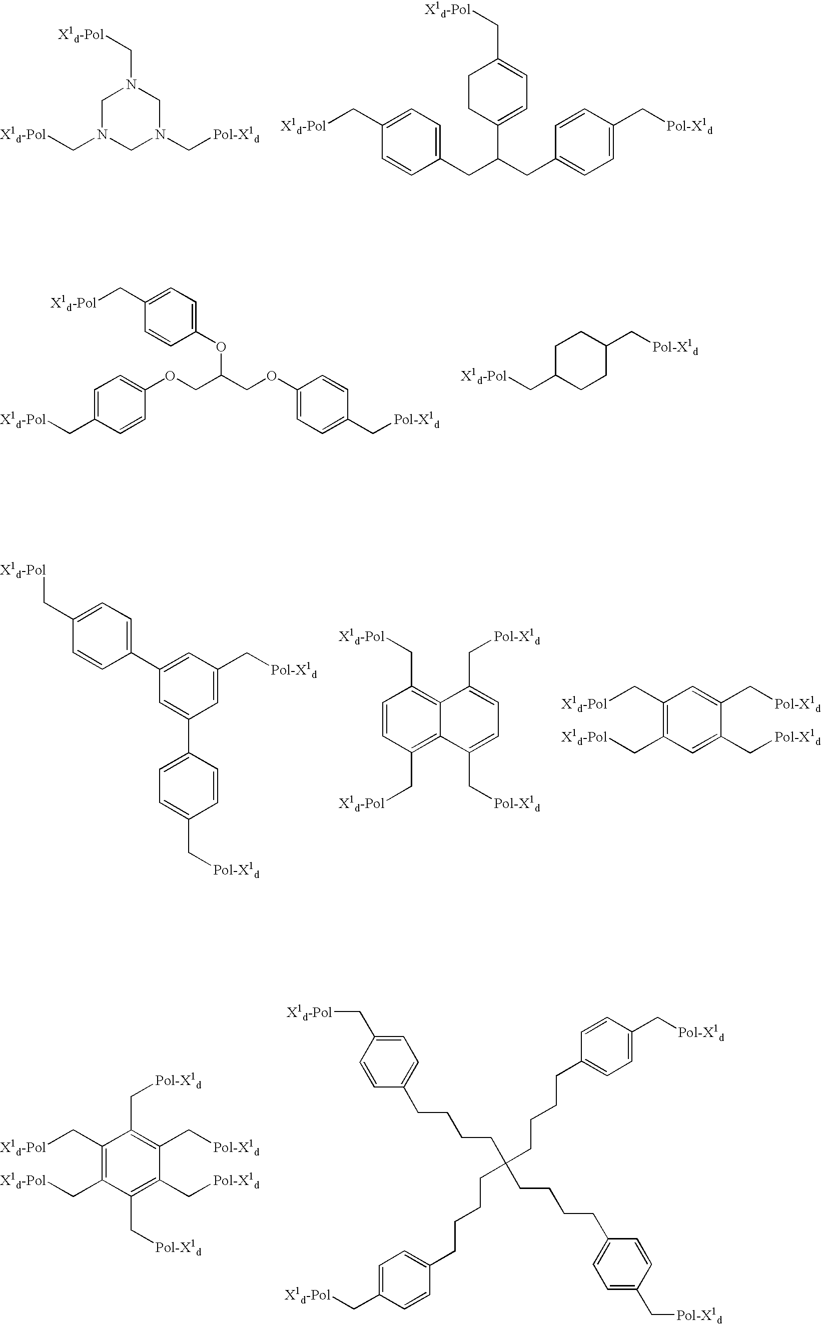

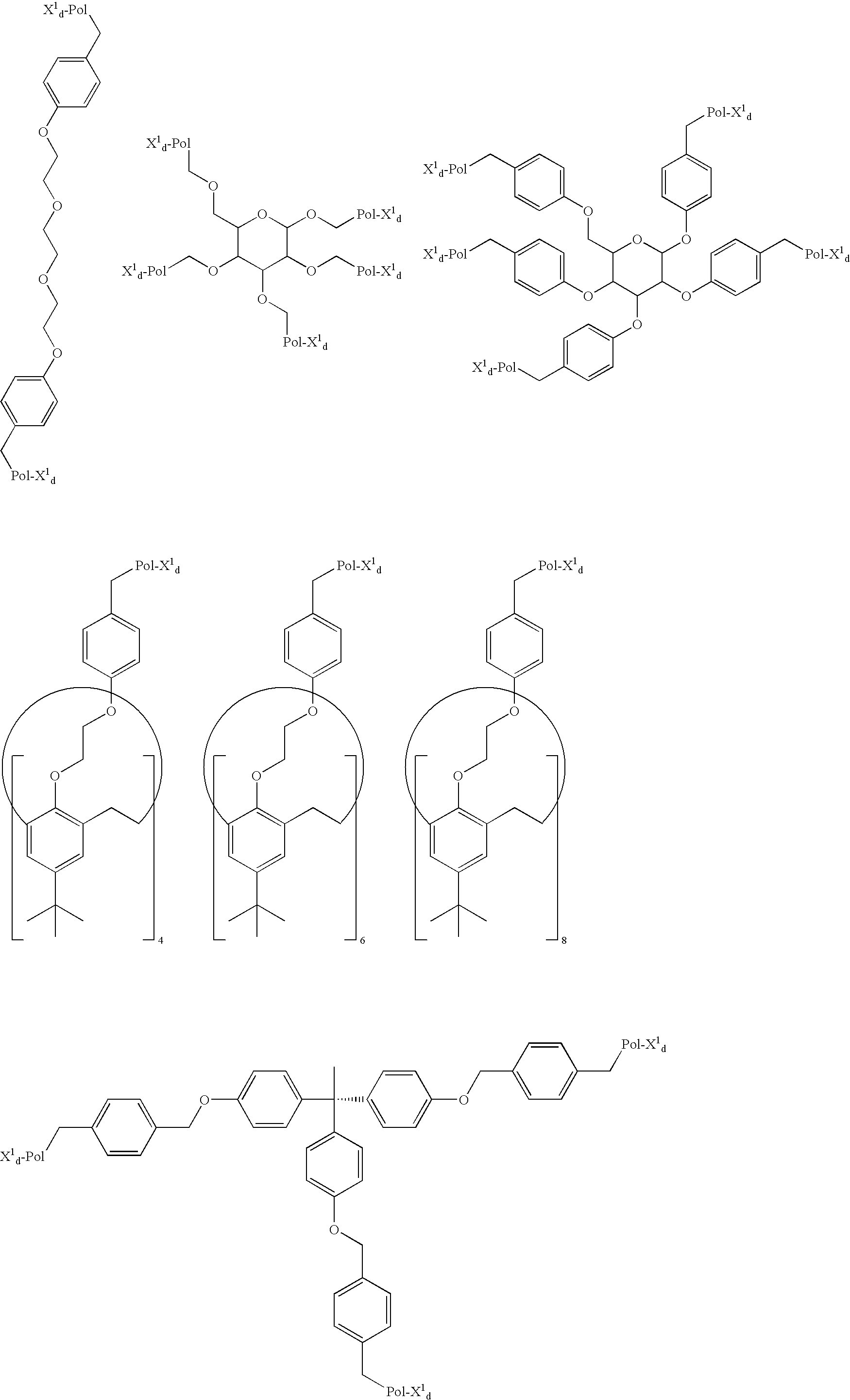

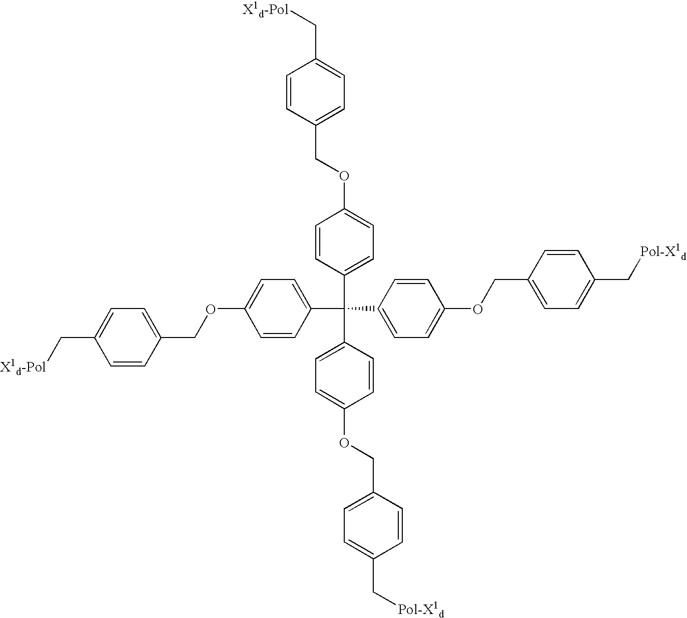

in which

Pol is as defined above, and

X¹ is as defined above, and

d is as defined above.

An illustrative process, but one not restricting the invention, for preparing polyvinyl alcohols and polyvinyl alcohol copolymers, and for modifying polyvinyl alcohols and polyvinyl alcohol copolymers, is as follows:

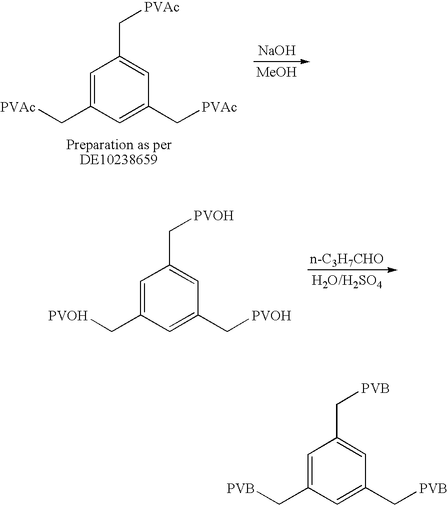

in which:

PVAc is polyvinyl acetate and

PVOH is polyvinyl alcohol and

PVB is polyvinyl butyral,

Hydrolysis of the polyvinyl acetate (M_{w}=64 000 g/mol) prepared in accordance with DE 10238659 and deriving from the parent structure 1,3,5-trismethylbenzene results in a polyvinyl alcohol (M_{w}=32 000 g/mol, T_{g}=55° C., Tₘ=184° C.) which on the basis of its lower melting point (comparative example: linear PVOH from Aldrich, ordering number 189499, batch number 07416KA: T_{g}=76° C., Tₘ=220° C.), in contrast to the PVOH of the comparative example, can be melted and has better processing properties. The polyvinyl alcohol derived from the 1,3,5-trismethylbenzene parent structure can be converted by reaction of butyraldehyde into the corresponding polyvinyl butyral.

The invention additionally provides for the use of the polyvinyl alcohols and polyvinyl alcohol copolymers of the invention as a protective colloid, emulsifier, binder, for protective skins and adhesives, textile finishes, sizes, metal-protection coatings, for preparing ointments and emulsions, water-soluble pouches and packaging films, oil-, grease-, and fuel-resistant films, hoses and seals, as an additive to shaving cream and to soaps, as a thickener in pharmaceutical and cosmetics products, as an artificial tear liquid, water-soluble fibers or sponges, films, a cement additive, hydrogels for water treatment, and as a polyvinyl alcohol that can be processed in the melt.

The invention further provides for the use of the polyvinyl acetals and polyvinyl acetal copolymers of the invention as films for producing laminated glass sheets, as base materials for coatings, as a component of adhesion primers, as textile coatings, as a component for adhesives, and as removable coatings.

The invention is illustrated by the following examples which do not, however, restrict the invention.

General notes: the organometallic compounds were prepared and handled in the absence of air and moisture, under inert argon gas (Schlenk technique or glove box). All solvents required were flushed with argon before use and rendered absolute over molecular sieve.

### EXAMPLE 1

### Preparation of a Polyvinyl Acetate Star Polymer in Accordance with DE 10238659

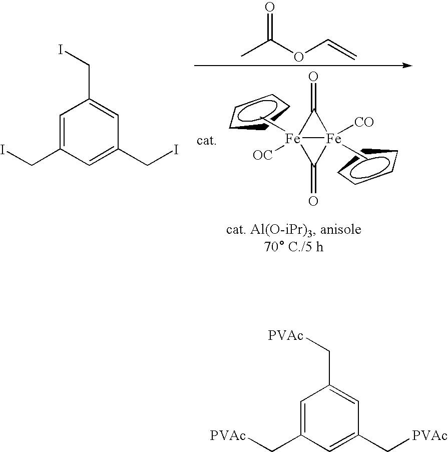

A heated 1 l three-neck flask with reflux condenser, KPG stirrer and pressure compensation (argon line) is charged with 2.6 g (7.5 mmol) of cyclopentadienyldicarbonyliron(I) dimer. Thereafter the apparatus is subjected to a triple operation of evacuation and blanketing with argon. Adding 12 ml of anisole (anhydrous and degassed) dissolves the iron catalyst. Then 276 ml of vinyl acetate (distilled), 2.5 g (5 mmol) of 1,3,5-trisiodomethylbenzene in 82 ml of anisole (anhydrous and degassed) and 30 ml of aluminum triisopropoxide in anisole (7.5 mmol Al(O-iPr)₃ in anisole, c=0.25 mol/l) are added. Thereafter the reaction mixture is heated at 70° C. for 5 hours with stirring with a KPG stirrer (160 rpm). The solvent and residual vinyl acetate are removed at 70° C. under reduced pressure. The reaction mixture is dissolved in 400 ml of acetone and this solution is added to 1.0 l of n-heptane. It is allowed to settle for an hour and then the supernatant n-heptane is decantered off. The dark brown polymer thus obtained is dried under reduced pressure for two hours and taken up again in 400 ml of acetone. The dark polymer solution is added dropwise and with vigorous stirring using a KPG stirrer to 1 l of an ice/2 M hydrochloric acid mixture (0.5 kg of ice/0.5 l of 2M HCl). The polymer powder thus produced is isolated by filtration, washed to neutrality with twice 125 ml of water, and freeze-dried under reduced pressure. The resulting polymer (yield: 105.4 g) is colorless and no longer contains anisole. ¹H NMR (500 MHz, CDCl₃): δ=7.03 (s, 3H, aromatic H), 4.85 (br., s, 3H, PVAC), 2.03 (m, 9H, PVAC), 1.83-1.45 (m, 6H, PVAc). GPC: M_{w}=64 000 g/mol, M_{w}/Mₙ=1.8. DSC: T_{g}=46° C.

### EXAMPLE 2

### Preparation of a Polyvinyl Alcohol Star Polymer

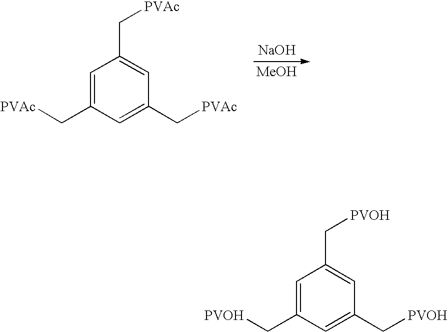

In a 1000 ml round-bottom flask 167 ml of a 1% strength methanolic sodium hydroxide solution are heated to 50° C. in a water bath. Added dropwise to this solution over a period of 30 minutes is a solution of 50 g of polyvinyl acetate star polymer (example 1) in 333 ml of methanol. The end of the addition is followed by stirring for 30 minutes. The white precipitate is isolated by filtration, washed alkali-free with methanol, and dried under reduced pressure. Yield: 25.0 g. ¹H NMR (500 MHz, [D₆]-DSMO): δ=6.65 (s, aromatic H), 4.65, 4.46, 3.89, 3.84, 3.31, 1.44-1.33 (4×s, 1×m, PVOH) ppm. DSC: T_{g}=55° C., Tₘ=184° C.

### EXAMPLE 3

### Preparation of a Polyvinyl Butyral Star Polymer

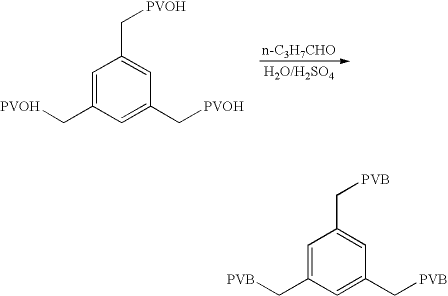

A 100 ml round-bottom flask is charged with 1.7 g of n-butyraldehyde, to which is added dropwise over the course of 2 minutes a solution, heated to 65° C., of 2.5 g of polyvinyl alcohol star polymer (example 2) in 25 ml of water/0.15 g of concentrated sulfuric acid. When addition is complete a further 0.5 g of concentrated sulfuric acid is added and the mixture is stirred at 55° C. for one hour. After the mixture has cooled to room temperature, the precipitate is isolated by filtration and washed to neutrality with water. The polymer is dissolved in 25 ml of warm methanol and the solution is added to 100 ml of water. The polymer is isolated by filtration and dried under reduced pressure. Yield: 4.2 g. ¹H NMR (500 MHz, [D₆]-DSMO): δ=6.69 (aromatic H), 4.69, 4.63, 4.41, 3.81, 3.55, 3.31, 1.44-1.21 (PVOH and alkyl groups) ppm.

1. A polymer of the formula I, II or III: 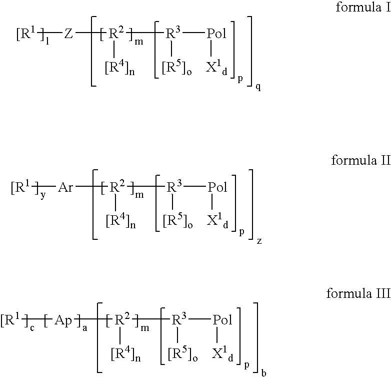
in which
Pol is a polymer based on a polyvinyl alcohol, and
Z is a central atom and is an atom from groups 13 to 16 of the Periodic Table of the Elements, and
X¹ is identical or different at each occurrence and is a halogen atom, and
R¹ is identical or different and is hydrogen or a C₁-C₂₀ group, and
R² is identical or different and is a bridging C₁-C₂₀ group between the central atom Z and the initiating unit [R³—X¹] or silicon or oxygen, and
R³ is identical or different and is carbon or silicon, and
R⁴ is identical or different and is a hydrogen atom or a C₁-C₂₀ group, and
R⁵ is identical or different and is hydrogen or a C₁-C₂₀ group,
l is a whole natural number and is zero, 1, 2 or 3, and
m is identical or different at each occurrence and is a whole natural number and is zero, 1, 2, 3, 4 or 5, and
n is identical or different at each occurrence and is a whole natural number and is zero, 1, 2, 3, 4, 5, 6, 7, 8, 9, 10, 11, 12, 13, 14, 15, 16, 17, 18, 19 or 20, and
is identical or different at each occurrence and is 1 or 2, and
p is identical or different at each occurrence and is a whole natal number and is 1, 2, 3, 4 or 5, and
q is a whole natural number and is 2, 3 or 4, and
Ar is an aromatic parent structure having at least four carbon atoms, in which one or more carbons may have been replaced by boron, nitrogen or phosphorus, with preferred aromatic or heteroaromatic parent structures deriving from benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which where appropriate may also be substituted, and
y is a whole natural number and is zero, 1, 2, 3, 4, 5, 6, 7, 8, 9, 10, 11, 12, 13, 14, 15, 16, 17, 18, 19 or 20, and
z is a whole natural number and is 2, 3, 4, 5, 6, 7, 8, 9 or 10,
Ap is a cyclic nonaromatic parent structure which has at least three carbon atoms and may also contain heteroatoms from the group of nitrogen, boron, phosphorus, oxygen or sulfur, and
a is a whole natural number and is zero, 1, 2, 3, 4, 5, 6, 7, 8, 9, 10, 11, 12, 13, 14, 15, 16, 17, 18, 19 or 20, and
b is a whole-natural number and is 2, 3, 4, 5, 6, 7, 8, 9 or 10, and
c is a whole natural number and is zero, 1, 2, 3, 4, 5, 6, 7, 8, 9, 10, 11, 12, 13, 14, 15, 16, 17, 18, 19 or 20, and
d can be identical or different and is zero or one.

2. The polymer of claim 1, characterized in that Pol is a copolymer based on polyvinyl alcohol.

3. The polymer of claim 1, characterized in that Pol is a polyvinyl alcohol-polyvinyl acetate copolymer, polyvinyl alcohol-polyethylene copolymer, polyvinyl alcohol-polyvinyl chloride copolymer or polyvinyl alcohol-polymethyl acrylate copolymer or mixture thereof.

4. The polymer of claim 1, characterized in that Z is a central atom selected form the group of carbon, silicon, nitrogen, phosphorus, oxygen and/or sulfur.

5. The polymer of claim 1, characterized in that X¹ is identical or different at each occurrence and is fluorine, chlorine, bromine or iodine.

6. The polymer of claim 1, characterized in that Ar is benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which if desired may also be substituted.

7. The polymer of claim 1, characterized in that Ap is cyclopropyl, cyclobutyl cyclopentyl, cyclohexyl, cycloheptyl, cyclooctyl or cyclononyl, aziridine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, alpha-glucose and/or beta-glucose.

8. A process for preparing a polyvinyl acetal or polyvinyl acetal copolymer, characterized in that at least one polymer of claim 1 is used.

9. A polyvinyl acetal or polyvinyl acetal copolymer obtainable by reacting at least one polymer of claim 1.

10. (canceled)

11. The use of the polymer of claim 9 as a film for producing laminated glass sheets, as a base material for coatings, as a component of adhesion primers, as a textile coating, as a component for adhesives or as a removable coating.

12. The polymer of claim 3, wherein
Z is a central atom selected form the group of carbon, silicon, nitrogen, phosphorus, oxygen and/or sulfur,
X¹ is identical or different at each occurrence and is fluorine, chlorine, bromine or iodine,
Ar is benzene, biphenyl, naphthalene, anthracene, phenanthrene, triphenylene, quinoline, pyridine, bipyridine, pyridazine, pyrimidine, pyrazine, triazine, benzopyrrole, benzotriazole, benzopyridine, benzopyrazidine, benzopyrimidine, benzopyrazine, benzotriazine, indolizine, quinolizine, carbazole, acridine, phenazine, benzoquinoline, phenoxazine, which if desired may also be substituted,
Ap is cyclopropyl, cyclobutyl, cyclopentyl, cyclohexyl, cycloheptyl, cyclooctyl or cyclononyl, aziridine, azetidine, pyrrolidine, piperidine, azepane, azocane, 1,3,5-triazinane, 1,3,5-trioxane, oxetane, furan, dihydrofuran, tetrahydrofuran, pyran, dihydropyran, tetrahydropyran, oxepane, oxocane, alpha-glucose and/or beta-glucose.

13. A protective colloid, emulsifier, binder, for protective skins and adhesives, textile finishes, sizes, metal-protection coatings, for preparing ointments and emulsions, water-soluble pouches and packaging films, oil-, grease-, and fuel-resistant films, hoses and seals, as an additive to shaving cream and to soaps, as a thickener in pharmaceutical and cosmetics products, as an artificial tear liquid, water-soluble fibers or sponges, films, a cement additive, hydrogels for water treatment, and as a polyvinyl alcohol that can be processed in the melt, or for preparing polyvinyl acetal or polyvinyl acetal copolymer which comprises the polymer of claim 7.
